(19) United States
(12) Patent Application Publication
(10) Pub. No.: US 2007/0271144 A1
(43) Pub. Date: Nov. 22, 2007

(54) Method of Advertising

(76) Inventor: James Winquist, West Chicago, IL (US)

Correspondence Address: Welsh & Katz, Ltd.;Jon P. Christensen, 22nd Floor, 120 South Riverside Plaza, Chicago, IL, 60606, US

(21) Appl. No.: 11/748,123

(22) Filed: May 14, 2007

Related U.S. Application Data
(60) Provisional application No. 60/800,548, filed on May 15, 2006.

(51) Int. Cl. G06Q 30/00

(52) U.S. Cl. 705/14

(57) ABSTRACT

A method and apparatus for advertising to a plurality of consumers for the benefit of a plurality of merchants. The method includes the steps of providing a database searchable by the plurality of consumers of respective products and/or services offered by each of the plurality of merchants, providing a respective discount card to each of the plurality of consumers, upon presentation of the discount card by a consumer of the plurality of consumers to a merchant of the plurality of merchants, providing a discount for purchases of products and/or services made by the consumer from the merchant and periodically sending a respective record of discounts received by each of the plurality of consumers to the consumer.

### FIELD OF THE INVENTION

The field of the invention relates to commerce and more particularly to methods of advertising by merchants.

### BACKGROUND OF THE INVENTION

In the year 2004, $264B was spent in advertising within the United States, an increase of 8% over 2003. Yellow Pages spending alone represented $14B, an increase of 0.8% over 2003. Direct mail spending represented $52B, an increase of 8% over 2003.

It is difficult to measure a return on investment and the effectiveness of advertising. In addition, most advertising mediums will represent as many companies within a defined market segment as they can (e.g., the Yellow Pages) thereby reducing the impact of one merchant's advertising over another merchant's advertising.

On-line advertising can also be difficult to manage since ad placement is extremely dynamic and entirely driven by bidding. In this case, the effectiveness is limited by the number of people who view the on-line advertisement either by visiting a particular website or by selecting a particular pop-up ad.

In general, the difficulty with the use of advertising lies in correlating advertising with a decision to buy. While advertisers on high-end products may actually poll their customers, the cost of many products and number of consumers does not justify the extra cost.

One form of advertising involves the use of coupons. For example, 323 billion coupons were distributed in 2005, an increase of nearly 30 million coupons over the prior year. 88% of these were distributed via Sunday papers. Yet, despite spending much more on coupons in 2005, consumer response in redeeming coupons was down 6%. The attributed reason to the lower redemption rate is the lower perceived value of coupons by consumers and the inconvenience of cutting, carrying and redeeming coupons.

In general, coupons attract price shoppers and do not create loyalty. It is difficult to measure the effectiveness of coupon advertising in generating new sales, i.e., those sales that would not have happened without the coupon. For most small to medium sized businesses, coupon tracking is a frustrating manual process. The average coupon expires in 2.9 months with 94% of all coupons expiring in 5 months or less. The average consumer is overwhelmed and inundated with coupons and coupon programs. On-line coupons are further hampered in that they require pre-planning and do not allow spontaneity.

While advertising through the distribution of information or coupons is effective at some level, it falls short of achieving its intended purpose. Accordingly, a need exists for better methods of advertising.

### SUMMARY

A method and apparatus for advertising to a plurality of consumers for the benefit of a plurality of merchants. The method includes the steps of providing a database searchable by the plurality of consumers of respective products and/or services offered by each of the plurality of merchants, providing a respective discount card to each of the plurality of consumers, upon presentation of the discount card by a consumer of the plurality of consumers to a merchant of the plurality of merchants, providing a discount for purchases of products and/or services made by the consumer from the merchant and periodically sending a respective record of discounts received by each of the plurality of consumers to the consumer.

### BRIEF DESCRIPTION OF THE DRAWINGS

FIG. 1 is a block diagram of an advertising system shown generally in accordance with an illustrated embodiment of the invention.

### DETAILED DESCRIPTION OF AN ILLUSTRATED EMBODIMENT

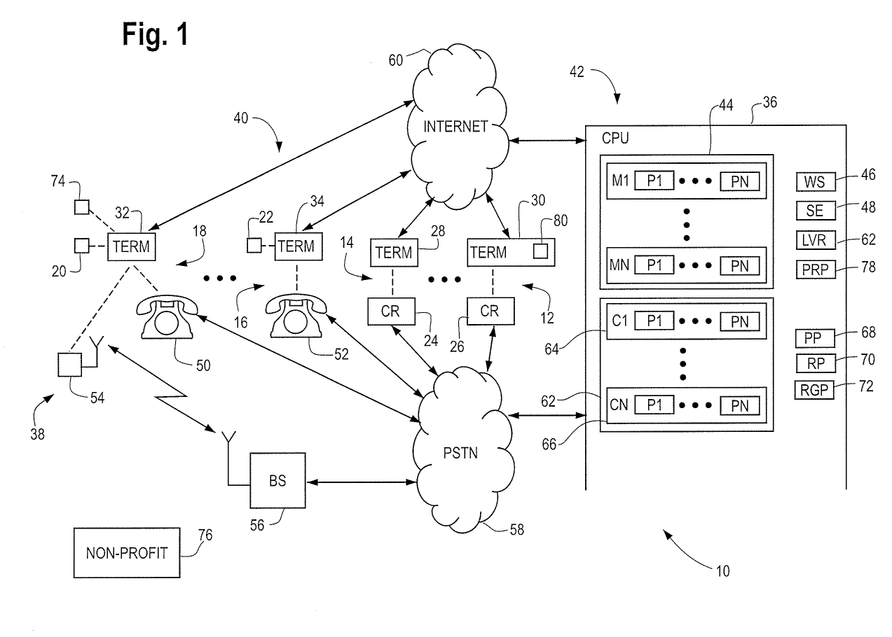

FIG. 1 is a block diagram of an advertising system 10 that may be used by a number of merchants 12, 14 for advertising to a number of consumers 16, 18 generally in accordance with an illustrated embodiment of the invention. The system 10 may be operated and controlled by a third party advertising organization and involves the use of the first known hard-copy coupon (card) with feedback.

The coupon card may be carried and used by members in a way that generates profit and advertising for merchants. In the member market, the coupon card is the easiest way to ensure consistent savings for members and a great user experience.

In the non-profit market, the coupon card is one of the best ways to reward loyal supporters and build a broader support base while raising significant funds for the non-profit organization. The model supported by the coupon card not only provides a greater donor benefit, but also passes a higher percentage of the sale value to the nonprofit than most traditional fund-raising vehicles.

The coupon card may be provided as a magnetic strip card, smart card, RFID or any other similar, portable data storage medium. The coupon card operates a means to fulfill an ongoing loyalty program that provides immediate cash savings. The coupon card also operates as a means to fulfill an ongoing merchant advertising program. The coupon card also functions as a means of tracking customer activity, buying habits, etc. for the purpose of modifying the merchant's product or service offering or advertising and promotional activity on a monthly basis.

The unique concept of using a coupon card creates data that can be aggregated, measured and reported to all participants to verify their return on investment. Furthermore, as the advertising organization collects and maintains data on usage of the program by members and partner providers the advertising organization is able to: 1) personalize each user's experience with our product; 2) incorporate actual user results into program improvement and new program development, and 3) incorporate on-going research into the effectiveness/results derived from the program by its users.

In general, the system 10 provides a database that is searchable by consumers 16, 18 for respective products and/or services offered by merchants 12, 14. The system 10 relies upon a respective discount card that is provided to each of the plurality of consumers. Upon presentation of the discount card by a consumer to a merchant, a discount is provided for purchases of products and/or services made by the consumer from the merchant. The system 10 also periodically sends a respective record of purchases made and discounts received by each of the consumers to the consumer.

In general, the advertising system 10 may be divided into three parts. The first part is the advertising system 38, the second is the purchasing system 40 and the third is the reporting system 42. It should be noted that these divisions have been made for convenience only and for purposes of understanding the invention since the purchasing system 40 and reporting system 42 also function to provide advertising in a manner that is discussed in more detail below.

The advertising system 38 may include any of a number of communication devices used by a consumer 16, 18 to search or receive information from a data base 44 within a host 36 controlled by the advertising organization. For example, consumers 16, 18 may own and use a respective terminal 32, 34 to access a web site 46 of the advertising organization (and associated search engine 48) through the Internet 60 to search for a merchant 12, 14 based upon subject matter of the product and/or service. Alternatively, the terminal 32, 34 may be used by the consumer 16, 18 to receive advertising about special offerings about products and/or services from vendors 12, 14 under an appropriate format (e.g., e-mail, instant messaging, etc.).

Alternatively, a consumer 16, 18 may use a personal digital assistant (PDA) 54 to access the database 44 through a local cellular base station 56 and the PSTN 58 or through a gateway (not shown) to the Internet 60. As with the terminals 32, 24, the consumer 16, 18 may search for and receive information about merchants 12, 14.

Similarly, the advertising system 38 may include one or more switched circuit devices that allow a consumer 16, 18 to search for and receive information from the database 44. For example, consumers 16, 18 may use a respective telephone 50, 52 or cell phone 54. In this case, the switched circuit connection may be formed between the consumer 16, 18 and an interactive voice response unit (IVR) 62 within the host 36. Voice recognition may be used to accept search terms and/or geographical identifiers (e.g., zip codes) for locating a particular product and/or service or to identify of a merchant 12, 14. The search terms or geographical area may again be provided to the search engine 48 that retrieves information and provides the retrieved information as a voice response through the switched circuit connection to the consumer 16, 18.

The purchasing system 40 relies upon a discount card 20, 22 carried by the consumer 16, 18. In this regard, each consumer 16, 18 may receive a discount card 20, 22 issued by the advertising organization, for use in obtaining discounts from merchants 12, 14 in the purchase of goods and/or services. To obtain a discount, the consumer 16, 18 presents the card 20, 22 to the merchant 12, 14 at the time of purchase along with a form of payment (e.g., cash, credit card, debit card, etc.).

Upon receipt of the discount card 20, 22 and form of payment, the merchant 12, 14 swipes the card 20, 22 through a card reader 24, 26 associated with a point of sale terminal, calculates a total payment and subtracts the discount. The consumer 16, 18 pays the total amount, less discount, and the merchant 12, 14 releases the consumer 16, 18 of any further obligation.

The presentation and swiping of the card 20, 22 through the card reader 24, 26 accomplishes at least two things. First, it collects an identifier of the consumer 16, 18 from the card 20, 22 and identifies the consumer 16, 18 as being entitled to receive the discount. The card reader 24, 26 may do this by sending a status query to a purchase processor 68 within the host 36. The purchase processor 68 may response with a status of the card 20, 22 (e.g., in good standing, lost, stolen, etc.).

Second, the card reader 24, 26 retrieves information about the sale including the purchase information along with the discount and identifier of the consumer 16, 18, composes a summary report in the form of a purchase file and sends the file to a consumer purchases data base 62 within the host 36. The purchase processor 68 receives the file, retrieves the identifier of the consumer 16, 18 and matches the identifier with an identifier of a corresponding file 64, 66 of the consumer 16, 18. The summary purchase file may be saved as a new purchase in the corresponding file 64, 66.

In the case where the merchant 12, 14 has an existing point of sale (POS) terminal 28, 30, then the functionality of the card reader 24, 26 may be incorporated into the terminal 28, 30. In this case, the functionality of the card reader 24, 26 may be repeated through the installation of a reporting software module 80 that reports transactions to the database 62 through the Internet 60.

The reporting system 42 includes the consumer database 62 and a reporting processor 70. The reporting processor 70 periodically retrieves a list of consumer purchases 64, 66 from the data base 62 and sends a summary of such purchases (e.g., including date, identifier of the merchant 12, 14, amount of purchase, amount of discount, etc.) to the consumer 16, 18. The summary may be sent to an e-mail address of the consumer 16, 18 or may be sent as a hard copy through the U.S. Mail.

The benefits to consumers 16, 18 and merchants 12, 14 accrue from a number of sources. On a first level, the cards 20, 22 can be sold by the organization for some nominal value (e.g., $50/year). In this case, the consumer 16, 18 provides his/her name and address to the organization.

In order to activate the card 20, 22, the consumer 16, 18 may go to the web site 46 and activate a card activation softkey on one of the web pages. In this case, the consumer 16, 18 may be requested to enter his name and address as a security feature to verify the sale. The consumer 16, 18 may also be asked if the consumer 16, 18 wishes to receive promotional material related to the consumer's frequent purchases. The consumer 16, 18 may also be requested to enter his e-mail address to facilitate delivery of purchase reports. In response, a registration processor 72 may accept the consumer's name, address and e-mail address and open a file 64, 66.

Alternatively, the consumer 16, 18 may register the card 20, 22 by calling a registration number associated with the organization. In this case, the consumer 16, 18 is connected to the IVR 62 and the process continues as described above.

The registration processor 72 may also generate and send an initial list 74 of merchants 12, 14 and associated products and services to the registering consumer 16, 18. The list 74 may be indexed by the subject matter of the product and/or services (e.g., fine dining) or may be indexed alphabetically based upon the name of the merchant 12, 14. The list may be e-mailed to the consumer 16, 18 or mailed.

Advertising of the merchant's products and/or services accrues on a first level from the distribution of the initial list. Advertising accrues on still another level when a consumer 16, 18 enters a key word or search term through the search engine 48 and receives a name of the merchant 12, 14.

A further benefit accrues from the ability of a visitor to an area to call an access number of the IVR 62 using a cell phone 54 and select a search of the area in which the visitor is located for a particular product and/or service. The consumer 16, 18 may do this by accessing the IVR 62 and saying or selecting a city or a zip code from a directory. The city or zip code may be transferred to the search engine 48 where the appropriate area may be selected.

Following the selection of a geographic area, the consumer 16, 18 may enter a search term (e.g., Italian restaurants). The term is again transferred to the search engine 48. The search engine 48 may return a number of restaurants and provide them in the form of a list to the consumer 16, 18. The consumer 16, 18 may select a restaurant from the list. Once a restaurant is selected, the search engine 48 may recite a menu of options including foods offered, address and telephone number. The consumer 16, 18 may select the menu and be offered a list of dishes offered and price. Alternatively, the consumer 16, 18 may select the telephone number and the consumer 16, 18 may call the merchant 12, 14 directly.

The organization operating the system 10 may offer referrals to visitors free of charge or may charge a small fee. In the case of where the organization charges for referrals, the cost may be any appropriate amount (e.g., $0.25 to $10).

As an alternative to selling the cards 20, 22, one or more of the merchants 12, 14 may choose to give them away (i.e., free of charge) for a predetermined time (e.g., 6 months) as an advertising mechanism. In this case, the merchant 12, 14 may imprint an advertising message on the card 20, 22.

Where the merchant 12, 14 gives the cards 20, 22 away, the merchant 12, 14 may pay a fee to the advertising organization. The merchant 12, 14 may also provide the name and address of the intended recipients of the cards. The recipient consumers 16, 18 may register the card 20, 22 for use as discussed above. After the predetermined time period, the recipient consumer 16, 18 may pay an additional fee for continued use of the card 20, 22.

In addition, to receiving advertising based upon the initial list 74 and search results, the consumer 16, 18 may also agree to accept promotional information related to the consumer's frequent purchases. In this case, merchants 12, 14 may periodically submit special offers. In this case, a promotions processor 78 may match special offers from merchants 12, 14 with purchases made by consumers 16, 18. When a match is made, the promotions processor 78 may incorporate the content of the special offer from the merchant 16, 18 into an e-mail and send the special offer to consumers 16, 18 with similar buying habits. Since it is the advertising organization that forwards the special offers, the privacy of the consumer 16, 18 is protected.

As an alternative to merchants 16, 18 giving the cards 20, 22 away, non-profit organizations may sell the cards 20, 22 for use during a predetermined time period. In this case, the sale of the cards 20, 22 may result in income for the non-profit organization 76. For the predetermined period, the non-profit organization may receive a portion of the fees (e.g., 60%). If the consumer 16, 18 should choose to renew the membership after the predetermined time period, the non-profit organization 76 may receive a portion of the renewal fees (e.g., 60%).

In another illustrated embodiment, the functionality of the card 20, 22 may be incorporated into a credit card. In this case, the card readers 24, 26 may be provided with additional software to read both the credit card number and member information. In other ways, the credit card/discount card 20, 22 may operate in the same manner as discussed above.

In general, there are approximately a dozen or more revenue-generating components to the system 10. While each is valuable in its own right, the synergy among the components creates a level of value that far exceeds the sum of the individual parts.

On a first level, possession of a card 20, 22 (i.e., membership) generates a revenue stream on an individual basis (e.g., $50/card). Membership and a willingness to invest in a card 20, 22 arise from a number of sources.

On a first level, each card 20, 22 is unique. The uniqueness allows the system 10 to track usage of the card on the basis of the individual transaction.

On another level, pre-screened partner providers (i.e., merchants 12, 14) help to ensure a pleasant experience. Screening in this case involves selection of merchants 12, 14 who meet a predefined criteria regarding quality, customer service and stability.

On another level, membership offers immediate preferential member savings at all participating provider merchants 12, 14. Discounts are applied to a final bill, not granted after some waiting period.

There is no limit on usage of the card 20, 22 with participating merchants 12, 14. In this case, there is no limit on the number of times per time period that the card 20, 22 can be used with a particular merchant 12, 14.

Membership also allows access to members web site 46. Searches may be performed through the web site 46 or via a telephone.

Membership provides for monthly on-line statements of purchases and savings. The statements provide a further level of advertising because it provides a ready source of how much money a user has saved during a month.

Additional revenues to the organization using the system 10 is available from non-profit annual membership sales. The non-profit organization receives the majority of fees for the first year (e.g., 60%) while the organization using the system 10 receives all residual fees.

Benefits to the non-Profit organization include the large percent of card sale price retained (60% vs. 30-40% for competitive merchant discount services). The use of the card 20, 22 also provides an excellent donor benefit. In addition, the high renewal rate generated by the savings available through use of the card 20, 22 lowers campaign costs for sale of the cards 20, 22 to consumers 16, 18.

Significant revenues may be generated for the advertising organization through use of a merchant advertising program. For example, a merchant 12, 14 may be charged a base rate (e.g., $95/year) annual membership fee, plus a monthly fee. The monthly fee may be based upon the geographical area in which the merchant 12, 14 operates and within which the system 10 provides advertising. For example, a local program may require a first fee (e.g., $245/month) for listing in 3 zip codes. Listing, in this case, means that if a search term related to the merchant's products and/or services is submitted in any of the three zip codes, the merchant's name and products and/or services will be returned as a search result.

Similarly, a district program may require a second fee (e.g., $395/month) for listings in 6 zip codes. Other additional programs may require a third and fourth fees, respectively, (e.g., $830/month and $3,095/month) for an area program (e.g., one area code) or a chapter program (e.g., entire coverage are).

Merchants 12, 14 provide a minimum discount of 15% off the entire member transaction with consumers 16, 18. Merchants are encouraged to provide the best possible deal to their captive card member constituent in order to maximize the value created for all. Special discounts of as much as 70% may be offered for 1500Club web specials.

Merchants 12, 14 receive a number of benefits from their use of the system 10. One overriding benefit is that the merchant advertiser incurs significantly reduced advertising costs. Another benefit is in increased exposure to out of town, national card-holding members.

Another benefit is in a measured, quantified and reported value of advertising results. For example, if the system 10 sends an e-mail to a consumer 16, 18 (based upon the consumer's previous consent) about a special offering, then the system 10 can also detect any response to the merchant's special. In this case, the results are detected and reported based upon the use of the card 20, 22. Data on card use in response to any special offerings can be reported to the merchant 12, 14 without any violation of the consumer's privacy.

The merchant 12, 14 also has the ability to adjust volume and exposure in his/her advertising to target select cardholders 16, 18. The merchant 12, 14 may do this by limiting or expanding his offer to certain geographic areas for predetermined time periods.

The merchant 12, 14 also benefits because the system 10 is a private program. There is no need to offer the same savings to the public at large.

Moreover, the program offered to each merchant 12, 14 is customized to fit their needs. Large merchants 12, 14 can expand their geographic area as needed. Smaller merchants 12, 14 may choose a smaller geographic area.

Moreover, the web site 46 of the system 10 may be structured as an interactive micro-web site. In this case, the term “interactive micro-website” refers to a system wherein the website 46 of the host 36 returns hyperlinks to a merchant's website. The hyperlink may take the consumer 16, 18 to a website of the merchant or simply cause a pop-up ad of the merchant to appear in a browser of the consumer 16, 18. This reduces the overhead on the host 36. The use of the inter-active micro-website provides top-of-mind positioning to card members

The system 10 may also provide monthly email blasts that can be targeted for desired sales impact. In this case, the term “blast” refers to the aggregation of offers from many merchants and distribution at a predetermined date of the month. This reduces the impression that the blast is simply spam.

The system 10 may also provide an electronic bulletin board. The electronic bulletin board may post additional offers from merchants or critiques of merchant performance provided by consumers 16, 18.

Revenues received by the advertising organization from merchants 12, 14 for use of the system 10 can be structured in any number of ways. For example, a fine dining advertising program may be provided for a $95 to $295 annual membership fee with no monthly fees. Fine dining partners provide a guaranteed savings off of the entire meal price (including drinks) according to the following discount schedule: a) one person 20%; b) two people 30%; c) three to four people 25%; d) five to six people 20% and e) seven or more people 15%.

Fine dining partners (i.e., merchants 12, 14) must provide service to consumers 16, 18 either Friday or Saturday evening in addition to all other days of operation. Fine dining partner (i.e., merchant) benefits include: a) free advertising to entire chapter; b) new patrons and c) repeat loyal customers. The preferential savings (i.e., the variable discount rate) encourages card members not to save money but to spend more money. It fills idle tables and maximizes capacity utilization. It also reduces advertising costs and increases exposure to out of town, national card-holding members.

The benefit to the merchant 12, 14 of the fine dining program includes a measured, quantified and reported value for use of the advertising program provided by the system 10, as discussed above. The program also offers a choice of distribution area and sizes and the ability to adjust volume and exposure to target select cardholders. The fine dining program is a private program and, therefore, there is no need to offer the same savings to the general public. The program is customized to fit the needs of the merchant 12, 14. The inter-active micro-website, monthly email blast and electronic bulletin board offer other benefits.

Another source of revenue from merchants 12, 14 is a casual dining and fast food program. The casual dining and fast food program may be offered for a $95 to $295 annual membership fee, plus an additional $125 to $250/month based upon advertising. (The consumer 16, 18 receives the same benefits as fine dining above.)

A specific embodiment of method and apparatus for advertising for products and/or services of merchants has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A method of advertising to a plurality of consumers for the benefit of a plurality of merchants, such method comprising:
providing a database searchable by the plurality of consumers of respective products and/or services offered by each of the plurality of merchants;
providing a respective discount card to each of the plurality of consumers;
upon presentation of the discount card by a consumer of the plurality of consumers to a merchant of the plurality of merchants, providing a discount for purchases of products and/or services made by the consumer from the merchant; and
periodically sending a respective record of discounts received by each of the plurality of consumers to the consumer.

2. The method of advertising as in claim 1 further comprising a merchant of the plurality of merchants imprinting an advertisement of the merchant on the discount card and distributing the card free of charge for a predetermined time period to at least some of the plurality of consumers.

3. The method of advertising as in claim 1 further comprising a non-profit organization selling the cards for a predetermined sale price and retaining a portion of the sale price.

4. The method of advertising as in claim 3 further comprising a consumer of the plurality of consumers renewing a membership by paying a renewal fee for the card and the non-profit organization receiving a portion of the renewal fee.

5. The method of advertising as in claim 1 wherein the searchable database further comprises as a web site accessible through the Internet.

6. The method of advertising as in claim 5 further comprising accessing the searchable database through a personal digital assistant.

7. The method of advertising as in claim 1 wherein the searchable database further comprises as an interactive voice response unit accessed through the public switch telephone network.

8. The method of advertising as in claim 7 further comprising connecting to the searchable database using a cell phone.

9. The method of advertising as in claim 1 further comprising incorporating the discount card into a credit card.

10. The method of advertising as in claim 1 wherein the step of providing the discount card further comprises providing the plurality of consumers with a product and/or service listing indexed by product and/or service and by merchant.

11. An apparatus for advertising to a plurality of consumers for the benefit of a plurality of merchants, such apparatus comprising:
means for providing a database searchable by the plurality of consumers of respective products and/or services offered by each of the plurality of merchants;
a respective discount card provided to each of the plurality of consumers;
means, upon presentation of the discount card by a consumer of the plurality of consumers to a merchant of the plurality of merchants, for providing a discount for purchases of products and/or services made by the consumer from the merchant; and
means for periodically sending a respective record of discounts received by each of the plurality of consumers to the consumer.

12. The apparatus for advertising as in claim 11 further comprising an advertisement of the merchant imprinted on the discount card and distributing free of charge for a predetermined time period to at least some of the plurality of consumers.

13. The apparatus for advertising as in claim 11 further comprising at least some discount cards distributed by a non-profit organization for a predetermined sale price where the non-profit organization retains a portion of the sale price.

14. The apparatus for advertising as in claim 13 further comprising the non-profit organization receiving at least a portion of a renewal fee for the at least some cards.

15. The apparatus for advertising as in claim 11 wherein the means for providing the searchable database further comprises a web site accessible through the Internet.

16. The apparatus for advertising as in claim 15 further comprising means for accessing the searchable database through a personal digital assistant.

17. The apparatus for advertising as in claim 11 wherein the searchable database further comprises as an interactive voice response unit accessed through the public switch telephone network.

18. The apparatus for advertising as in claim 17 further comprising means for accessing the searchable database using a cell phone.

19. The apparatus for advertising as in claim 11 further comprising a credit card incorporating a functionality of the discount card.

20. The apparatus for advertising as in claim 11 wherein the searchable database further comprises a listing indexed by product and/or service or by merchant.

21. An apparatus for advertising to a plurality of consumers for the benefit of a plurality of merchants, such apparatus comprising:
a database searchable by the plurality of consumers of respective products and/or services offered by each of the plurality of merchants;
a respective discount card provided to each of the plurality of consumers;
a merchant of the plurality of merchants that provides a discount for purchases of products and/or services made by the consumer from the merchant upon presentation of the discount card by a consumer of the plurality of consumers; and
a report processor that periodically sends a respective record of discounts received by each of the plurality of consumers to the consumer.

22. The apparatus for advertising as in claim 21 further comprising an advertisement of the merchant imprinted on the discount card and distributing free of charge for a predetermined time period to at least some of the plurality of consumers.

23. The apparatus for advertising as in claim 21 further comprising at least some discount cards distributed by a non-profit organization for a predetermined sale price where the non-profit organization retains a portion of the sale price.

24. The apparatus for advertising as in claim 23 further comprising the non-profit organization receiving at least a portion of a renewal fee for the at least some cards.

25. The apparatus for advertising as in claim 21 wherein the searchable database further comprises a web site accessible through the Internet.

26. The apparatus for advertising as in claim 25 wherein the searchable database further comprises a personal digital assistant accessing the searchable database.

27. The apparatus for advertising as in claim 21 further comprising an interactive voice response unit accessed through the public switch telephone network that provides an interface to the searchable database.

28. The apparatus for advertising as in claim 27 further comprising a cell phone that accesses the interactive voice response unit through the public switch telephone network.

29. The apparatus for advertising as in claim 21 further comprising a credit card incorporating a functionality of the discount card.

30. The apparatus for advertising as in claim 21 wherein the searchable database further comprises a listing indexed by product and/or service or by merchant.
